(19) United States
(12) Patent Application Publication
(10) Pub. No.: US 2024/0376353 A1
(43) Pub. Date: Nov. 14, 2024

(54) TWO-COMPONENT STRUCTURAL ADHESIVE

(71) Applicant: DDP SPECIALTY ELECTRONIC MATERIALS US, LLC, Wilmington, DE (US)

(72) Inventors: Felix Koch, Freienbach (CH); Daniel Schneider, Freienbach (CH); Beda Steiner, Freienbach (CH)

(21) Appl. No.: 18/683,166

(22) PCT Filed: Jul. 8, 2022
(86) PCT No.: PCT/US2022/036482

§ 371 Date: Feb. 12, 2024

Related U.S. Application Data
(60) Provisional application No. 63/238,459, filed on Aug. 30, 2021.

(51) Int. Cl. C09J 11/08; C08G 18/22; C08G 18/24; C08G 18/48; C08G 18/73; C08G 18/75; C09J 163/00

(52) U.S. Cl. CPC C09J 11/08; C08G 18/222; C08G 18/227; C08G 18/242; C08G 18/4825; C08G 18/4854; C08G 18/73; C08G 18/755; C09J 163/00

(57) ABSTRACT

Provided herein is a two-component adhesive composition showing excellent adhesive strength after heat and humidity exposure.

### FIELD OF INVENTION

The present invention relates to the field of two-component epoxy adhesives, particularly toughened epoxy adhesives that are curable at ambient conditions and showing good mechanical characteristics.

### BACKGROUND OF THE INVENTION

Toughened two-component epoxy structural adhesives are used extensively in the automotive and other industries for metal-metal bonding as well as bonding metals to other materials. Often, these structural adhesives must strongly resist failure during vehicle collision situations. Structural adhesives of this type are sometimes referred to as “crash durable adhesives”, or “CDAs”. This attribute is achieved through the presence of certain types of materials in the adhesive formulation. These materials are often referred to as “tougheners”. The tougheners have blocked functional groups that, under the conditions of the curing reaction, can become de-blocked and react with an epoxy resin. Tougheners of this type are described, for example, in U.S. Pat. Nos. 5,202,390, 5,278,257, WO 2005/118734, WO 2007/003650, WO2012/091842, U. S. Published Patent Application No. 2005/0070634, U. S. Published Patent Application No. 2005/0209401, U. S. Published Patent Application 2006/0276601, EP-A-0 308 664, EP 1 498 441A, EP-A 1 728 825, EP-A 1 896 517, EP-A 1 916 269, EP-A 1 916 270, EP-A 1 916 272 and EP-A-1 916 285.

U.S. Pat. No. 9,181,463 describes epoxy-based adhesives comprising a toughener made by reacting a poly(tetramethylene ether)glycol (“PolyTHF” or “PTMEG”), with a diisocyanate, then chain extending the resulting prepolymer with O,O′-diallylbisphenol A, followed by capping of the isocyanate groups with a mono- or di-phenol. Such adhesives are said to show good storage stability and cure to form cured adhesives that have good lap shear and impact peel strengths.

Once incorporated into an epoxy resin, during curing tougheners with phenol-capped isocyanate end groups will react with either hydroxyl or amine groups in the epoxy matrix. The more end-groups of the toughener that react, the better the mechanical characteristics of the cured adhesive.

The tougheners for such heat-curing structural adhesives typically contain a heat labile capping group which is cleaved at the high temperatures of cure, unmasking a reactive function which allows the toughener to react with and covalently link with the epoxy matrix. Commonly used tougheners contain one or more reactive aliphatic isocyanate end-groups which are capped with phenols. At temperatures of 180° C. the reaction of an aliphatic isocyanate with a phenol is typically reversible, meaning the phenol moiety is cleaved and the reactive isocyanate is regenerated. This is often referred to as “deblocking” of the toughener.

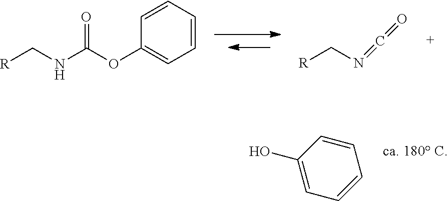

After deblocking, the free isocyanate can react with the hydroxy groups of the epoxy resin or the amine groups of a hardener to form an excellent interface between toughener particles and matrix. The result is a toughener phase dispersed in the epoxy matrix, while being covalently linked into the epoxy matrix.

Heating the assembly to ca. 180° C., in order to cause deblocking, is energy and time-consuming, and can cause distortion if the adhered parts expand differentially under thermal exposure. A need exists for tougheners that can react with the epoxy matrix at lower temperatures.

### SUMMARY OF THE INVENTION

In a first aspect, provided herein is a two-component epoxy adhesive composition comprising:

### Component A:

ai) at least one epoxy resin;
aii) a reactive toughener made by reacting at least one polyol and optionally poly(butadiene)diol with a polyisocyanate in the presence of a polyurethane catalyst, optionally followed by chain extension with a di-phenol, and end-capping with a molecule of Formula I:

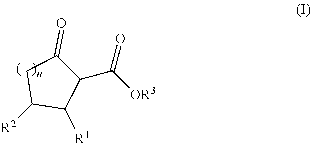

where R¹ and R² are independently selected from hydrogen and C₁ to C₆ alkyl, n is an integer from 1 to 2, and R³ is C₁ to C₆ alkyl;

### Component B:

bi) one or more polyamines;
bii) optionally one or more latent epoxy curing agents;
biii) one or more epoxy curing catalysts.

In a second aspect, the invention provides a cured adhesive resulting from mixing the above Components A and B, and allowing the resulting mixture to cure.

In a third aspect, the invention provides a method for adhering two substrates, comprising the steps:

1. providing a two-component epoxy adhesive composition comprising:

### Component A:

ai) at least one epoxy resin;
aii) a reactive toughener made by reacting at least one polyol and optionally poly(butadiene)diol with a polyisocyanate in the presence of a polyurethane catalyst, optionally followed by chain extension with a di-phenol, and end-capping with a molecule of Formula I:

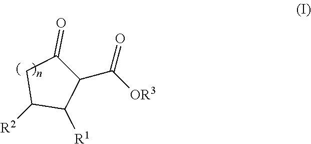

where R¹ and R² are independently selected from hydrogen and C₁ to C₆ alkyl, n is an integer from 1 to 2, and R³ is C₁ to C₆ alkyl;

### Component B:

bi) one or more polyamines;
bii) optionally one or more latent epoxy curing agents;
biii) one or more epoxy curing catalysts;
2. mixing Components A and B to make a mixture;
3. applying the mixture to a first substrate and/or a second substrate;
4. placing the substrates such their surfaces are in adhesive contact, with a layer of the mixture in between; and
5. allowing the mixture to cure.

In a fourth aspect, the invention provides an adhered assembly comprising:
1. a first substrate;
2. a second substrate;
3. a cured adhesive adhering the first and second substrates, wherein the cured adhesive is obtained by mixing the following Components A and B to produce a mixture, and allowing the mixture to cure:

### Component A:

ai) at least one epoxy resin;
aii) a reactive toughener made by reacting at least one polyol and optionally poly(butadiene)diol with a polyisocyanate in the presence of a polyurethane catalyst, optionally followed by chain extension with a di-phenol, and end-capping with a molecule of Formula I:

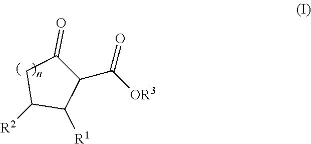

where R¹ and R² are independently selected from hydrogen and C₁ to C₆ alkyl, n is an integer from 1 to 2, and R³ is C₁ to C₆ alkyl;

### Component B:

bi) one or more polyamines;
bii) optionally one or more latent epoxy curing agents;
biii) one or more epoxy curing catalysts.

### DETAILED DESCRIPTION OF THE INVENTION

The inventors have surprisingly found that by decreasing the toughener content in an epoxy adhesive, adhesive performance after heat and humidity exposure is significantly improved.

### Definitions and Abbreviations

PTMEG poly(tetramethylene oxide) glycol
DGEBA bis-phenol A diglycidyl ether
polyTHF poly(tetramethylene oxide) glycol
PBD poly(butadiene)diol
DBTL dibutyl tin dilaurate
HDI hexamethylene diisocyanate
CPEE Ethyl-2-oxocyclopentanecarboxylate
PTHF poly(tetrahydrofuran)

Molecular weights of polymers as reported herein are reported in Daltons (Da) as number or weight average molecular weights, as determined by size exclusion chromatography (SEC).

The two-component adhesive of the invention consists of a Component A (resin component), and a Component B (hardener component). In use, Component A and Component B are mixed in a desired ratio, and then applied to a substrate or substrates.

### Component A

Component A comprises ai) at least one epoxy resin and aii) at least one reactive toughener.

### Epoxy Resin

Component A of the two-component adhesive of the invention contains at least one epoxy resin. Epoxy resins useful in adhesive compositions according to this invention include a wide variety of curable epoxy compounds and combinations thereof. Useful epoxy resins include liquids, solids, and mixtures thereof. Typically, the epoxy compounds are epoxy resins which are also referred to as polyepoxides. Polyepoxides useful herein can be monomeric (e.g., the diglycidyl ether of bisphenol A, diglycidyl ether of bisphenol F, diglycidyl ether of tetrabromobisphenol A, novolac-based epoxy resins, and tris-functional epoxy resins), higher molecular weight resins (e.g., the diglycidyl ether of bisphenol A advanced with bisphenol A) or polymerized unsaturated monoepoxides (e.g., glycidyl acrylates, glycidyl methacrylate, allyl glycidyl ether, etc.) to homopolymers or copolymers. Most desirably, epoxy compounds contain, on the average, at least one pendant or terminal 1,2 epoxy group (i.e., vicinal epoxy group) per molecule. Solid epoxy resins that may be used in the present invention preferably can comprise or preferably be based upon mainly bisphenol A. Some preferred epoxy resins include, for example, D.E.R. 330, D.E.R. 331, and D.E.R. 671, all commercially available from The Dow Chemical Company.

One preferable epoxy resin has general formula:

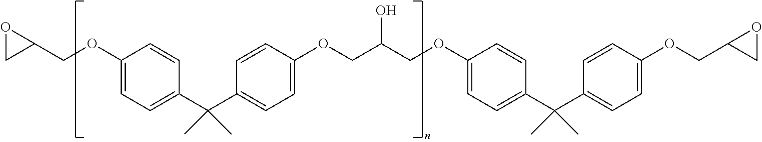

where n is in the range of 0 to about 25.

Preferred epoxy resins have epoxy equivalent weights in the range of about 170 to 195 g/mol.

Combinations of epoxy resins may be used to adjust properties of the epoxy adhesive. In compositions and methods of the present invention, the epoxy adhesive may comprise any amount of epoxy resin. Preferably, the liquid and/or solid epoxy resin comprise more than or about 20 wt %, more preferably more than or about 25 wt %, 30 wt % or 35 wt %, of the epoxy adhesive. Preferably, the liquid and/or solid epoxy resin comprise less than or about 65 wt %, more preferably less than or about 55 wt % or 45 wt %, of the epoxy adhesive. Other preferred amounts are shown in the Examples. Ranges formed from pairs of these values (e.g., 25 to 35 wt %, 25 to 65 wt %, 30 to 38 wt % (adhesive AA)) are also preferred.

When a combination of liquid and solid epoxy resins is used, any proportion can be used, and can be determined by one of ordinary skill in the art. In order to obtain a suitable viscosity, it is generally preferred that the weight proportion of liquid to solid epoxy resin is greater than 50:50. Epoxy adhesive compositions of the present invention preferably comprise liquid and solid epoxy resins in a ratio of, or greater than, 55:45, 65:35, or 70:30. Epoxy adhesive compositions of the present invention preferably comprise liquid and solid epoxy resins in a ratio of, or less than, 100:0, 99:1, 90:10, or 85:10. Other preferred ratios are shown in the Examples. Ranges formed from pairs of these values (e.g. 50:50 to 100:0, 65:35 to 82:18 (adhesive AU)) are also preferred.

### Preferred Epoxy Resins Include:

Epoxy 1. A liquid reaction product of epichlorohydrin and bisphenol A, having an epoxide equivalent weight of 182-192 g/eq (as measured according to ASTM D-1652), an epoxide percentage of 22.4-23.6% (as measured according to ASTM D-1652), an epoxide group content of 5200-5500 mmol/kg (as measured according to ASTM D-1652), and a viscosity at 25° C. of 4000-14000 mPas (as measured according to ASTM D-445), for example, DER 331;

Epoxy 2. A solid epoxy resin is a low molecular weight solid reaction product of epichlorohydrin and Bisphenol-A, having an epoxide equivalent weight of 475-550 g/eq (as measured according to ASTM D-1652), an epoxide percentage of 7.8-9.1% (as measured according to ASTM D-1652), an epoxide group content of 1820-2110 mmol/kg (as measured according to ASTM D-1652), and a melt viscosity at 150° C. of 400-950 mPas (as measured according to ASTM D-4287), for example, DER 671;

### 3. Mixtures of Epoxy 1 and Epoxy 2.

Particularly preferred is Epoxy 1.

The epoxy resin is preferably present in the adhesives of the invention at 50 to 80 wt %, more preferably 55 to 75 wt %, particularly preferably at 60 to 72 wt %, based on the total weight of Component A of the adhesive.

In a particularly preferred embodiment, the epoxy resin is Epoxy 1, used at 62 to 72 wt %, based on the total weight of Component A of the adhesive.

### Reactive Toughener

Component A of the two-component adhesives of the invention comprises a specific toughener.

The tougheners used in the inventive compositions are reactive tougheners made by reacting at least one polyol and optionally poly(butadiene)diol with a polyisocyanate in the presence of a polyurethane catalyst, optionally followed by chain extension with a di-phenol, and end-capping with a molecule of Formula I:

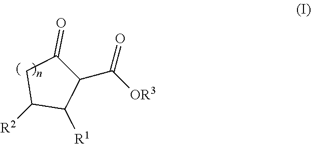

where R¹ and R² are independently selected from hydrogen and C₁ to C₆ alkyl, n is an integer from 1 to 2, and R³ is C₁ to C₆ alkyl.

In a preferred embodiment, R¹ and R² are independently selected from H and C₁ to C₄ alkyl, more preferably H and C₁ to C₂ alkyl, particularly preferably R¹ and R² are H.

In a preferred embodiment, R³ is C₁ to C₄ alkyl, more preferably C₁ to C₂ alkyl.

In a preferred embodiment, n is 1.

In another preferred embodiment, R¹ and R² are H, R³ is ethyl or methyl, particularly ethyl, and n is 1. In a particularly preferred embodiment, the capping molecule is CPEE.

In a preferred embodiment PBD is included in the toughener backbone.

In another preferred embodiment, chain extension with a di-phenol is carried out.

In another preferred embodiment, PBD is included and chain extension with a di-phenol is carried out.

In another preferred embodiment, PBD is not included.

In another preferred embodiment, chain extension is not carried out.

In another preferred embodiment, PBD is not included and chain extension is not carried out.

The at least one polyol is preferably a diol or triol or mixture of both. Diols are particularly preferred. In a preferred embodiment, the at least one polyol is a poly(alkylene oxide) diol. Preferred poly(alkylene oxide)diols are selected from poly(C₂-C₆ alkylene oxide) diols, particularly poly(tetramethylene oxide)diol (“PTMEG”), poly(trimethylene oxide)diol (“PO3G”), and mixtures of these. The poly(alkylene oxide)diol preferably has a molecular weight in the range of 1,000 to 2,500 Da, more preferably 1,000, to 2,000 Da. PTMEG is particularly preferred. Preferably, the PTMEG has a molecular weight in the range of 1,000 to 2,500 Da, more preferably 1,000 to 2,000 Da.

The PBD preferably has a molecular weight in the range of 2,000 to 3,500 Da, more preferably 2,800 Da.

The polyisocyanate is not particularly limited. Aliphatic diisocyanates and cycloaliphatic diisocyanates are preferred, with 1,6-Hexamethylenediisocyanate (“HMDI” or “HDI”) and isophorone diisocyanate (IPDI) being particular examples. HMDI is particularly preferred.

The polyurethane catalyst is not particularly limited. Dibutyltin dilaurate (“DBTL”) and metal carboxylates, such as bismuth and/or zinc carboxylates, are particularly preferred. The catalyst is preferably used at 0.01 to 0.5 wt %, more preferably 0.1 wt %, based on the total weight of the toughener. In a preferred embodiment, the catalyst is a mixture of bismuth and zinc carboxylates, used at 0.1 wt %, based on the total weight of the toughener.

Optional chain extension is carried out with a di-phenol. O,O′-diallylbisphenol A (“ODBA”) is particularly preferred. The di-phenol is preferably used at 2 to 10 wt %, more preferably 5 to 8 wt %, particularly preferably 7 wt %, based on the total weight of the toughener. Alternatively, the chain-extender may be used at a molar ratio to the polyol of from 0:1 to 1:1, more preferably 0:1 to 0.8:1, particularly preferably 0.6:1 to 0.8:1.

Reaction of the diol, polyisocyanate and diphenol chain extender (if used) are such that the molecule before capping is terminated with NCO groups. End-capping is then carried out with the molecule of Formula I, using an appropriate catalyst, such as, for example, at least one metal carboxylate, particularly zinc and/or bismuth carboxylates.

The toughener preferably contains 40 to 90 wt % polyol, in particular poly(alkylene oxide)diol, more preferably 45 to 85 wt %, more particularly preferably 50 to 85 wt %, based on the total weight of the toughener. Particularly preferably the toughener contains 40 to 90 wt % PTMEG, more preferably 45 to 85 wt %, more particularly preferably 50 to 85 wt %, based on the total weight of the toughener. PTMEG's having molecular weights of 1,000, 1,400 and 2,000 Da are particularly preferred.

If present, PBD is preferably present in the toughener at 10 to 25 wt % PBD, more preferably 12 to 18 wt %, based on the total weight of the toughener, with PBD having a molecular weight of 2,800 Da being particularly preferred.

A preferred toughener comprises 50 to 85 wt % PTMEG, 7 to 20 wt % HDI and to 15 wt % of the capping group, in particular CPEE.

A preferred toughener comprises 50 to 85 wt % PTMEG, 10 to 20 wt %, more preferably 12 to 18 wt % PBD, 7 to 20 wt % HDI and 5 to 15 wt % of the capping group, in particular CPEE.

Some examples of preferred tougheners are made by reacting the following components (wt %'s are based on the total weight of the toughener):

TABLE A
Examples of some preferred tougheners to be used in the adhesives
of the invention (wt %’s based on total weight of the toughener)

| Ingredient | | | | |
|---|---|---|---|---|
| (molecular weight) | 1 | 2 | 3 | 6 |
| PolyTHF (2000) | 74.92 | 82.59 | 66.54 | 70.42 |
| PBD (2800) | | | 16.64 | |
| 1,6-HDI | 12.60 | 10.42 | 10.09 | 17.76 |
| Catalyst (blend of | 0.10 | 0.10 | 0.10 | 0.10 |
| bismuth and zinc | | | | |
| carboxylates) | | | | |
| CPEE | 12.38 | 6.89 | 6.63 | 11.72 |

A preferred method for making the toughener is the following process:

1. First reaction step: the polyol, preferably poly(alkylene oxide)diol (more preferably PTMEG) and PBD (if used) are heated to 120-130° C. The mixture is heated for 25-35 minutes under vacuum. The mixture is cooled to 50-70° C. When the temperature reaches 50-70° C. diisocyanate (preferably HDI) is added and the mixture is mixed for 2-5 minutes. The polyurethane catalyst is then added (for example, metal carboxylate, such as bismuth and/or zinc carboxylate) and the mixture is allowed to react at 75-90° C. (bath temperature) for 40-50 minutes under a neutral atmosphere (e.g. nitrogen, argon).

2. Second reaction step: the chain extender (if used) is added and the mixture is stirred for 50-70 minutes at 85-95° C. (bath temperature) under a neutral atmosphere (e.g. nitrogen, argon).

3. Third reaction step: the end-capping molecule of Formula I is added (for example, CPEE) and the mixture is stirred for 80-95 minutes at 85-95° C. (bath temperature) under a neutral atmosphere (e.g. nitrogen, argon). The mixture is stirred for 10 minutes at 95° C. under vacuum for degassing.

A particularly preferred toughener is made using the above process using the components listed in Table A (wt %'s are based on the total weight of the toughener).

### Other Ingredients of Component A

Component A may comprise additional optional ingredients, such as, for example:

One or more silane adhesion promoters, for example tris(diethylene glycol methylether) silyl propyleneglycidylether.

Monofunctional, difunctional and trifunctional epoxy-reactive diluents, such as di-phenols, monophenols, for example cardanol, monoglycidyl ethers of C₁₂₋₁₄-alcohols, (trimethylolpropane triglycidylether) resins, and diglycidyl ether of cyclohexane dimethanol.

Plasticizers, such as phthalates and dialkyl naphthalenes, in particular dialkyl phthalates, for example di-iso-nonyl phthalate and dialkyl naphthalenes, such as di-iso-propyl naphthalene.

Fillers, such as calcium carbonate, TiO₂, fumed silica, Wollastonite, glass in the form of fibres, microspheres, flakes, carbon fibers, graphite.

Thermally conductive fillers such as aluminum hydroxide (ATH), alumina, spherical alumina, aluminum, zinc oxide, boron nitride, diamond or combinations thereof.

### Component B

Component B comprises bi) one or more polyamines, bii) optionally one or more latent epoxy curing agents, and biii) one or more epoxy curing catalysts.

### Polyamines

Component B comprises at least one polyamine that is capable of cross-linking with epoxy groups on the epoxy resin. Polyamines include molecules with two or more amine groups. In a preferred embodiment, the polyamine has an amine functionality of 3 or greater, more preferably greater than 10.

In another preferred embodiment, the polyamine comprises at least one molecule having an amine functionality of 10 or greater, in combination with one or more diamines.

In another preferred embodiment, the polyamine comprises at least one molecule having an amine functionality of 10 or greater, in combination with one or more triamines and one or more diamines.

Preferred polyamines include polymeric amines, low molecular weight amines, and combinations thereof.

In a preferred embodiment, the polyamine includes a polyetheramine, that is, molecules having a polyether backbone with terminal amine groups. Also preferred are reaction products of a stoichiometric excess of an amine prepolymer with an epoxy resin. The amine prepolymer may be any amine prepolymer that has at least two amine groups in order to allow cross-linking to take place. The amine prepolymer comprises primary and/or secondary amine groups, and preferably comprises primary amine groups. Suitable amine prepolymers include polyether diamines and polyether triamines, and mixtures thereof.

The polyetheramines may be linear, branched, or a mixture. Branched polyether amines are preferred. Any molecular weight polyetheramine may be used, with molecular weights in the range of 200-6000 or above being suitable. Molecular weights may be above 1000, or more preferably above 3000. Molecular weights of 3000 or 5000 are preferred.

Examples of suitable commercially available polyetheramines include:

TABLE B
Examples of polyamines that can be used in
Component B

| Trade name | Nature |
|---|---|
| Jeffamine T-403 | Polyetheramine characterized by repeating oxypropylene units in the |
| | backbone. JEFFAMINE T-403 is a trifunctional primary amine having |
| | an average molecular weight of approximately 440. Its amine groups |
| | are located on secondary carbon atoms at the ends of aliphatic |
| | polyether chains. |
| | 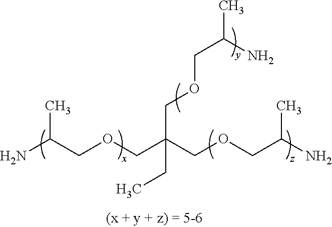 |
| Jeffamine D-400 | Polyoxypropylenediamine: an Amine-terminated polyoxypropylene diol |
| | 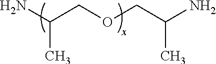 X ≈ 6.1 |
| Jeffamine D-2000 | Polyetheramine characterized by repeating |
| | oxypropylene units in the backbone. JEFFAMINE D- |
| | 2000 polyetheramine is a difunctional, primary amine |
| | with average molecular weight of about 2000. The |
| | primary amine groups are located on secondary carbon |
| | atoms at the end of the aliphatic polyether chains. |
| | 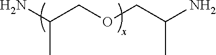 X ≈ 33 |
| TETA | Triethylenetetramine |
| Lupasol P | A branched aqueous solution of high molecular |
| | weight polyethylenimine homopolymer. |
| | 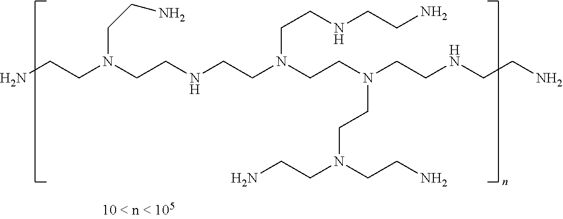 |
| 4,7,10-Trioxatri- decane-1,3-diamine | 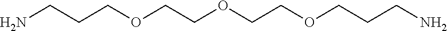 [SMILES: NCCCOCCOCCOCCCN] |
| | Mixtures of any of the above |

In a preferred embodiment, the polyamine of Component B comprises a mixture of Lupasol P, Jeffamine T-403, Jeffamine D-400, Jeffamine D-2000, and 4,7,10-Trioxatridecane-1, 13-diamine.

In another preferred embodiment, the polyamine of Component B comprises a mixture of Lupasol P, Jeffamine T-403, TETA, and 4,7,10-Trioxatridecane-1,13-diamine.

The concentration of polyamine in Component B will depend on the degree of cure that is desired in the cured adhesive, and also on the mixing ratio of Component A and Component B that is desired. In one preferred embodiment, in which the ratio of Component A to Component B is 2:1, the total polyamine content of Component B is from 30 to 70 wt %, more preferably 40 to 65 wt %, based on the total weight of Component B.

### Latent Epoxy Curing Agent

The adhesive may optionally contain a latent curing agent.

Suitable latent curing agents include materials such as boron trichloride/amine and boron trifluoride/amine complexes, melamine, diallylmelamine, guanamines such as dicyandiamide, methyl guanidine, dimethyl guanidine, trimethyl guanidine, tetramethyl guanidine, methylisobiguanidine, dimethylisobiguanidine, tetramethylisobiguandidine, heptamethylisobiguanidine, hexamethylisobiguanidine, acetoguanamine and benzoguanamine, aminotriazoles such as 3-amino-1,2,4-triazole, hydrazides such as adipic dihydrazide, stearic dihydrazide, isophthalic dihydrazide, semicarbazide, cyanoacetamide, and aromatic polyamines such as diaminodiphenylsulphones. Dicyandiamide is a particularly preferred curing agent.

The latent curing agent, if present, is used in an amount sufficient to cure the adhesive. Typically, enough of the curing agent is provided to consume at least 80% of the epoxide groups present in the composition. A large excess over that amount needed to consume all of the epoxide groups is generally not needed. Preferably, the curing agent constitutes at least about 1.5 weight percent of Component B, more preferably at least about 2.5 weight percent and even more preferably at least 3.0 weight percent thereof. The curing agent preferably constitutes up to about 10 weight percent of Component B, more preferably up to about 8 weight percent, and most preferably up to 5 weight percent.

In a preferred embodiment, the latent epoxy curing agent is dicyandiamide. The epoxy/dicyandiamide ratio constant (EP/Dicy ratio) is calculated by the ratio of the number of epoxy groups per kg to the number of dicy molecules per kg of the formulation. Preferably the dicyandiamide is present in an amount to give an epoxy/dicyandiamide ratio of about 5.

### Epoxy Curing Catalyst

The adhesive compositions of the invention comprise an epoxy curing catalyst.

The epoxy curing catalyst is one or more materials that catalyze the reaction of the epoxy resin(s) with the curing agent. Among preferred epoxy catalysts are ureas such as p-chlorophenyl-N,N-dimethylurea (Monuron), 3-phenyl-1,1 dimethylurea (Phenuron), 3,4-dichlorophenylN, N-dimethylurea (Diuron), N-(3 chloro-4-methylphenyl)-N′,N′-dimethylurea 25 (Chlortoluron), tert-acryl- or alkylene amines like benzyldimethylamine, 2,4,6-tris(dimethylaminomethyl)phenol, piperidine or derivatives thereof, various aliphatic urea compounds such as are described in EP1916272; C₁-C₁₂ alkylene imidazole or N-arylimidazoles, such as 2-ethyl-2-methylimidazol, or N-butylimidazole and 6-caprolactam, 2,4,6-tris(dimethylaminomethyl)phenol integrated into a poly(p-vinylphenol) matrix (as described in European patent EP0197892), or 2,4,6-tris(dimethylaminomethyl)phenol integrated into a novolac resin, including those described in U.S. Pat. No. 4,701,378, are suitable. Particularly preferred is tris-2,4,6-tris(dimethylaminomethyl)phenol integrated into a poly(p-vinylphenol) polymer matrix.

The epoxy curing catalyst may constitute, for example, from 1 to 20 wt %, more preferably 8 to 16 wt %, particularly preferably 10 to 14 wt %, based on the total weight of Component B.

In a preferred embodiment, the epoxy curing catalyst is 2,4,6-tris(dimethylaminomethyl)phenol integrated into a poly(p-vinylphenol) polymer matrix, used at an amount of 10 to 14 wt %, more preferably 12 wt %, based on the total weight of Component B.

### Other Ingredients of Component B

Component B may comprise additional optional ingredients, for example:

Fillers, such as TiO₂ calcium carbonate, fumed silica, Wollastonite, glass in the form of fibres, microspheres, flakes.

Rheology modifiers, such as surfactants, for example, non-ionic fluorosurfactants.

Monofunctional, difunctional and trifunctional epoxy-reactive diluents, such as di-phenols, monophenols, for example cardanol, monoglycidyl ethers of C₁₂₋₁₄-alcohols, (trimethylolpropane triglycidylether) resins, and diglycidyl ether of cyclohexane dimethanol.

Plasticizers, such as phthalates and dialkyl naphthalenes, in particular dialkyl phthalates, for example di-iso-nonyl phthalate, and dialkyl naphthalenes, such as di-iso-propyl naphthalene.

Thermally conductive fillers such as aluminum hydroxide (ATH), alumina, spherical alumina, aluminum, zinc oxide, boron nitride, diamond or combinations thereof.

### Cured Adhesive

In one aspect, the invention provides a cured adhesive resulting from mixing Components A and B described herein, and allowing the resulting mixture to cure.

Components A and B can be mixed by any method that provides a homogeneous mixture relatively rapidly. In a preferred embodiment, mixing is achieved using a static mixer at the time of dispensing Component and Component B, through nozzles.

The mixing ratio of Component A and Component B is determined by the concentration of reactive functionalities in Component A and Component B, and by the degree of cross-linking that is desired. In a preferred embodiment, the ratio of A:B is 1:1 or 2:1.

An advantage of the adhesives of the invention is that curing can be carried out at relatively low temperatures. In a preferred embodiment, curing can be carried out at less than 40° C., more preferably less than 30° C.

### Method of Adhering Substrates

In another aspect, the invention provides a method for adhering two substrates, comprising the steps:

1. providing a two-component epoxy adhesive composition comprising:

### Component A:

ai) at least one epoxy resin;
aii) a reactive toughener made by reacting at least one poly(alkylene oxide)diol and optionally poly(butadiene)diol with a polyisocyanate in the presence of a polyurethane catalyst, optionally followed by chain extension with a di-phenol, and end-capping with a molecule of Formula I:

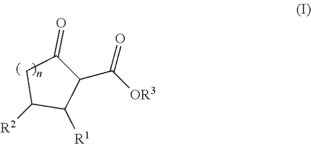

where R¹ and R² are independently selected from hydrogen and C₁ to C₆ alkyl, n is an integer from 1 to 2, and R³ is C₁ to C₆ alkyl;

### Component B:

bi) one or more polyamines;
bii) optionally one or more latent epoxy curing agents;
biii) one or more epoxy curing catalysts;
2. mixing Components A and B to make a mixture;
3. applying the mixture to a first substrate and/or a second substrate;
4. placing the substrates such their surfaces are in adhesive contact, with a layer of the mixture in between; and
5. allowing the mixture to cure.

The adhesives of the invention are particularly suited for adhering metal to metal, in particular steel, aluminium, magnesium, titanium, nickel-plated steel, stainless steel, coated steels typically used in the automotive industry, such as zinc coated steels, and zinc magnesium coated steels.

In a preferred embodiment, the first and second substrate are both metal, in particular steel or aluminum.

Components A and B can be mixed by any method that provides a homogeneous mixture relatively rapidly. In a preferred embodiment, mixing is achieved using a static mixer at the time of dispensing Component and Component B, through nozzles.

The mixing ratio of Component A and Component B is determined by the concentration of reactive functionalities in Component A and Component B, and by the degree of cross-linking that is desired. In a preferred embodiment, the ratio of A:B is 1:1 or 2:1.

An advantage of the adhesives of the invention is that curing can be carried out at relatively low temperatures. In a preferred embodiment, curing can be carried out at less than 40° C., more preferably less than 30° C. It is of course possible to reduce curing time by heating to above these temperatures, and the use of the adhesives of the invention in this way is also contemplated.

### Examples of Preferred Embodiments of the Invention

1. A two-component epoxy adhesive composition comprising:

### Component A:

ai) at least one epoxy resin;
aii) a reactive toughener made by reacting at least one polyol,
preferably poly(alkylene oxide)diol, and optionally poly(butadiene)diol with a polyisocyanate in the presence of a polyurethane catalyst, optionally followed by chain extension with a di-phenol, and end-capping with a molecule of Formula I:

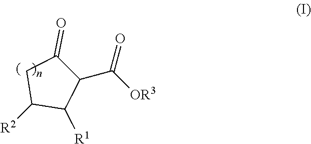

where R¹ and R² are independently selected from hydrogen and C₁ to C₆ alkyl, n is an integer from 1 to 2, and R³ is C₁ to C₆ alkyl;

### Component B:

bi) one or more polyamines;
bii) optionally one or more latent epoxy curing agents;
biii) one or more epoxy curing catalysts.

2. The composition of embodiment 1, wherein the at least one epoxy resin comprises an epoxy resin selected from those having epoxy equivalent weights in the range of about 170 to 195 g/mol.

3. The composition of embodiment 1 or 2, wherein the at least one epoxy resin comprises a liquid reaction product of epichlorohydrin and bisphenol A, having an epoxide equivalent weight of 182-192 g/eq (as measured according to ASTM D-1652)

4. The composition of embodiment 1, 2 or 3, wherein the at least one epoxy resin comprises an epoxy having an epoxide percentage of 22.4-23.6% (as measured according to ASTM D-1652), an epoxide group content of 5200-5500 mmol/kg (as measured according to ASTM D-1652).

5. The composition of any one preceding embodiment, wherein the at least one epoxy resin comprises an epoxy having a viscosity at 25° C. of 4000-14000 mPas (as measured according to ASTM D-445).

6. The composition of any one preceding embodiment, wherein the at least one epoxy resin is used at 50 to 80 wt %, more preferably 55 to 75 wt %, particularly preferably at 60 to 72 wt %, based on the total weight of Component A of the adhesive.

7. The composition of any one preceding embodiment, wherein R¹ and R² are independently selected from H and C₁ to C₄ alkyl.

8. The composition of any one preceding embodiment, wherein R¹ and R² are independently selected from H and C₁ to C₂ alkyl.

9. The composition of any one preceding embodiment, wherein R¹ and R² are H.

10. The composition of any one preceding embodiment, wherein R³ is C₁ to C₄ alkyl.

11. The composition of any one preceding embodiment, wherein R³ is C₁ to C₂ alkyl.

12. The composition of any one preceding embodiment, wherein R³ is ethyl.

13. The composition of any one preceding embodiment, wherein n is 1.

14. The composition of any one preceding embodiment, wherein the end-capping molecule is ethyl-2-oxocyclopentanecarboxylate.

15. The composition of any one preceding embodiment, wherein the poly(alkylene oxide)diol used in the toughener is selected from poly(C₂-C₆ alkylene oxide) diols.

16. The composition of any one preceding embodiment, wherein the poly(alkylene oxide)diol used in the toughener is selected from poly(tetramethylene oxide)diol (“PTMEG”), poly(trimethylene oxide)diol (“PO3G”), and mixtures of these.

17. The composition of any one preceding embodiment, wherein the poly(alkylene oxide)diol has a molecular weight in the range of 1,000 to 2,500 Da.

18. The composition of any one preceding embodiment, wherein the poly(alkylene oxide)diol has a molecular weight of 1,000, 1,400 or 2,000 Da, or a mixture of these is used.

19. The composition of any one preceding embodiment, wherein the poly(alkylene oxide)diol is PTMEG having a molecular weight in the range of 1,000 to 2,500 Da.

20. The composition of any one preceding embodiment, wherein poly(butadiene)diol (“PBD”) is used in the toughener.

21. The composition of embodiment 20, wherein the PBD has a molecular weight of in the range of 2,000 to 3,500 Da.

22. The composition of embodiment 20, wherein the PBD has a molecular weight of 2,800 Da.

23. The composition of any one preceding embodiment, wherein the at least one poly(alkylene oxide) diol is PTMEG and PBD is included in the toughener backbone.

24. The composition of any one preceding embodiment, wherein the at least one polyisocyanate used in the toughener is an aliphatic diisocyanate.

25. The composition of any one preceding embodiment, wherein the at least one polyisocyanate is selected from 1,6-hexamethylenediisocyanate (“HMDI”), isophorone diisocyanate (IPDI), and mixtures of these.

26. The composition of any one preceding embodiment, wherein the at least one polyisocyanate is hexamethylene diisocyanate (“HMDI”).

27. The composition of any one preceding embodiment, wherein chain extension is carried out with a diphenol.

28. The composition of embodiment 27, wherein the diphenol is O,O′-diallylbisphenol A.

29. The composition of any one preceding embodiment, wherein the polyurethane catalyst is selected from dibutyltin dilaurate (“DBTL”) and metal carboxylates, such as bismuth and/or zinc carboxylates.

30. The composition of any one preceding embodiment, wherein the polyurethane catalyst is used at 0.01 to 0.5 wt %, more preferably 0.1 wt %, based on the total weight of the toughener.

31. The composition of any one preceding embodiment, wherein the polyurethane catalyst is a mixture of bismuth and zinc carboxylates.

32. The composition of any one preceding embodiment, wherein the toughener contains 40 to 90 wt % poly(alkylene oxide)diol, based on the total weight of the toughener.

33. The composition of any one preceding embodiment, wherein the toughener contains 45 to 85 wt % poly(alkylene oxide)diol, based on the total weight of the toughener.

34. The composition of any one preceding embodiment, wherein the toughener contains 50 to 85 wt % poly(alkylene oxide)diol, based on the total weight of the toughener.

35. The composition of any one preceding embodiment, wherein the toughener comprises 50 to 85 wt % PTMEG, 7 to 20 wt % HDI and 5 to 15 wt % of the end-capping group, in particular CPEE, based on the total weight of the toughener.

36. The composition of any one preceding embodiment, wherein the toughener comprises 50 to 85 wt % PTMEG, 8 to 20 wt % PBD, 7 to 20 wt % HDI and 5 to 15 wt % of the end-capping group, in particular CPEE, based on the total weight of the toughener.

37. The composition of any one preceding embodiment, wherein the at least one polyamine in Component B has an amine functionality of 2 or greater.

38. The composition of any one preceding embodiment, wherein the at least one polyamine in Component B comprises at least one molecule having an amine functionality of 10 or greater, in combination with one or more diamines.

39. The composition of any one preceding embodiment, wherein the at least one polyamine in Component B comprises at least one polyetheramine.

40. The composition of any one preceding embodiment, wherein the at least one polyamine in Component B comprises primary and secondary amine groups.

41. The composition of any one preceding embodiment, wherein the at least one polyamine in Component B comprises primary amine groups.

42. The composition of any one preceding embodiment, wherein the at least one polyamine in Component B is selected from:

Polyamines

| Trade name | Nature |
|---|---|
| Jeffamine T-403 | Polyetheramine characterized by repeating oxypropylene units in the |
| | backbone. JEFFAMINE T-403 is a trifunctional primary amine having |
| | an average molecular weight of approximately 440. Its amine groups |
| | are located on secondary carbon atoms at the ends of aliphatic |
| | polyether chains. |
| | 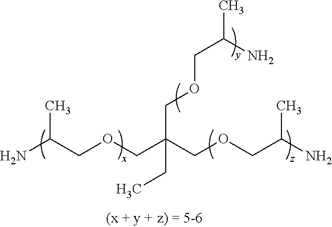 |
| Jeffamine D-400 | Polyoxypropylenediamine: an Amine-terminated polyoxypropylene diol |
| | 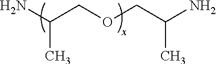 X ≈ 6.1 |
| Jeffamin D-2000 | Polyetheramine characterized by repeating oxypropylene units in |
| | the backbone. JEFFAMINE D-2000 polyetheramine is a |
| | difunctional, primary amine with average molecular weight of |
| | about 2000. The primary amine groups are located on secondary |
| | carbon atoms at the end of the aliphatic polyether chains. |
| | 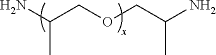 X ≈ 33 |
| TETA | Triethylenetetramine |
| Lupasol P | A branched aqueous solution of high molecular weight |
| | polyethylenimine homopolymer. |
| | 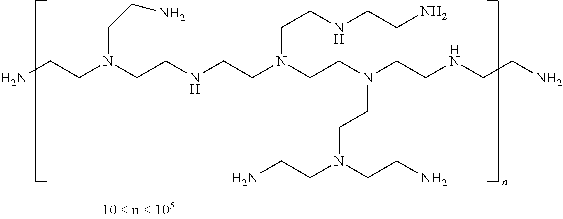 |
| 4,7,10-Trioxatri- decane-1,3-diamine | 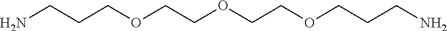 [SMILES: NCCCOCCOCCOCCCN] |

and mixtures of any of the above.

43. The composition of any one preceding embodiment, wherein the at least one polyamine in Component B comprises a mixture of Lupasol P, Jeffamine T-403, Jeffamine D-400, Jeffamine D-2000, and 4,7,10-Trioxatridecane-1,13-diamine.

44. The composition of any one preceding embodiment, wherein the at least one polyamine in Component B comprises a mixture of Lupasol P, Jeffamine T-403, TETA, and 4,7,10-Trioxatridecane-1,13-diamine.

45. The composition of any one preceding embodiment, wherein the latent epoxy curing agent is selected from boron trichloride/amine and boron trifluoride/amine complexes, melamine, diallylmelamine, guanamines such as dicyandiamide, methyl guanidine, dimethyl guanidine, trimethyl guanidine, tetramethyl guanidine, methylisobiguanidine, dimethylisobiguanidine, tetramethylisobiguandidine, heptamethylisobiguanidine, hexamethylisobiguanidine, acetoguanamine and benzoguanamine, aminotriazoles such as 3-amino-1,2,4-triazole, hydrazides such as adipic dihydrazide, stearic dihydrazide, isophthalic dihydrazide, semicarbazide, cyanoacetamide, and aromatic polyamines such as diaminodiphenylsulphones.

46. The composition of any one preceding embodiment, wherein the latent epoxy curing agent is dicyandiamide.

47. The composition of any one preceding embodiment, wherein the epoxy curing catalyst is selected from p-chlorophenyl-N,N-dimethylurea (Monuron), 3-phenyl-1,1 dimethylurea (Phenuron), 3,4-dichlorophenylN, N-dimethylurea (Diuron), N-(3 chloro-4-methylphenyl)-N′,N′-dimethylurea 25 (Chlortoluron), tert-acryl- or alkylene amines like benzyldimethylamine, 2,4,6-tris(dimethylaminomethyl)phenol, piperidine or derivatives thereof, C₁-C₁₂ alkylene imidazole or N-arylimidazoles, such as 2-ethyl-2-methylimidazol, or N-butylimidazole and 6-caprolactam, 2,4,6-tris(dimethylaminomethyl)phenol integrated into a poly(p-vinylphenol) matrix (as described in European patent EP0197892), or 2,4,6-tris(dimethylaminomethyl)phenol integrated into a novolac resin, including those described in U.S. Pat. No. 4,701,378.

48. The composition of any one preceding embodiment, wherein the epoxy curing catalyst is tris-2,4,6-tris(dimethylaminomethyl)phenol.

49. The composition of any one preceding embodiment, wherein the epoxy curing catalyst is present at 1 to 20 wt %, more preferably 8 to 16 wt %, particularly preferably 10 to 14 wt %, based on the total weight of Component B.

50. The composition of any one preceding embodiment, wherein the epoxy curing catalyst is 2,4,6-tris(dimethylaminomethyl)phenol integrated into a poly(p-vinylphenol) polymer matrix, used at an amount of 10 to 14 wt %, more preferably 12 wt %, based on the total weight of Component B.

51. A method for adhering two substrates, comprising the steps:
1. providing a two-component epoxy adhesive composition according to any one preceding embodiment;
2. mixing Components A and B to make a mixture;
3. applying the mixture to a first substrate and/or a second substrate;
4. placing the substrates such their surfaces are in adhesive contact, with a layer of the mixture in between; and
5. allowing the mixture to cure.

52. The method of embodiment 51, wherein the first and second substrates are metal, independently selected from steel and aluminium.

53. The method of embodiment 51 or 52, wherein the ratio of mixing Component A to Component B is 1:1 or 2:1.

54. The method of embodiment 51, 52 or 53, wherein curing is carried out at a temperature of less than 40° C.

### Effect of the Invention

After curing for seven days at room temperature, the adhesive compositions of the invention show excellent impact peel strength at 23° C. on steel, preferably 15 N/mm or greater.

After curing for seven days at room temperature, the adhesive compositions of the invention show excellent T peel strength at 23° C. on steel, preferably 3.5 N/mm or greater.

After curing for seven days at room temperature, the adhesive compositions of the invention show excellent E modulus, preferably 1,000 MPa or greater, more preferably 1,200 MPa or greater.

After curing for seven days at room temperature, the adhesive compositions of the invention show excellent tensile strength, preferably 23 MPa or greater, more preferably 25 MPa or greater.

### EXAMPLES

TABLE 1
List of ingredients used in tougheners and adhesives of the Examples

| Ingredient | Chemistry |
|---|---|
| PolyTHF 2000 | Polytetrahydrofuran-Diol 2000 g/mol |
| PolyVest HT | Hydroxylated Polybutadiene 2800 g/mol |
| 1.6 HDI (Desmodur H) | 1.6-hexamethylenediisocyanate |
| TIB KAT 718 | Blend of bismuth and zinc carboxylates |
| DBTL (DABCO T12) | Dibutyltin dilaureate |
| Cardolite NX2026 | high purity Cardanol |
| CPEE | Ethyl-2-oxocyclopentanecarboxylate 95+ % |
| | 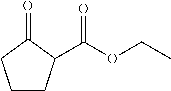 |
| D.E.R. 330 | A low viscosity bisphenol A epoxy resin, having an epoxide |
| | equivalent weight of 176-185 (ASTM D1652), epoxide group |
| | content (mmol/kg) of 5400-5680 (ASTM D1652) |
| D.E.R. 331 | a liquid reaction product of epichlorohydrin and bisphenol A, |
| | having an epoxide equivalent weight of 182-192 g/eq (as |
| | measured according to ASTM D-1652), an epoxide percentage |
| | of 22.4-23.6% (as measured according to ASTM D-1652), an |
| | epoxide group content of 5200-5500 mmol/kg (as measured |
| | according to ASTM D1652), and a viscosity at 25° C. of 11000- |
| | 14000 mPas (as measured according to ASTM D-445) |
| RAM 1087 | Tris(diethylene glycol methylether) silyl propyleneglycidylether |
| Araldit DW 0135 blau | Blue dye in bisphenol A-based epoxy resin |
| | (masterbatch) |
| Cardolite NC 700 | Cardanol |
| Jeffamin T-403 | polyetheramine characterized by repeating oxypropylene units in the |
| | backbone. As shown by the structure, JEFFAMINE T-403 is a |
| | trifunctional primary amine having an average molecular weight of |
| | approximately 440. Its amine groups are located on secondary carbon |
| | atoms at the ends of aliphatic polyether chains. |
| | 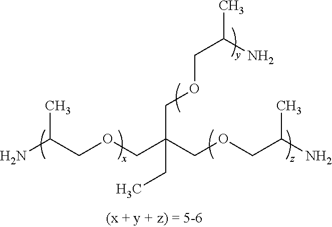 |
| Jeffamin D-400 | Polyoxypropylenediamine is an Amine-terminated polyoxypropylene |
| | diol |
| | 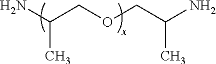 X ≈ 6.1 |
| Jeffamin D-2000 | polyetheramine characterized by repeating oxypropylene |
| | units in the backbone. As shown by the representative |
| | structure, JEFFAMINE D-2000 polyetheramine is a |
| | difunctional, primary amine with average molecular |
| | weight of about 2000. The primary amine groups are |
| | located on secondary carbon atoms at the end of the |
| | aliphatic polyether chains. |
| | 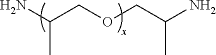 X ≈ 33 |
| TETA | Triethylenetetramine |
| Lupasol P | A branched aqueous solution of high molecular |
| | weight polyethylenimine homopolymer. |
| | 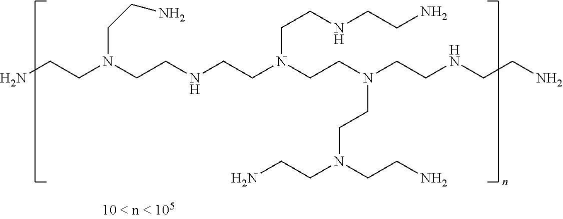 |
| 4,7,10-Trioxatridecane- 1,13-diamine | 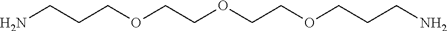 [SMILES: NCCCOCCOCCOCCCN] |
| Hypro ATBN 1300 × 16 | amine terminated butadienacrylonitrile copolymer |
| Fluorad FC 4430 | non-ionic polymeric fluorochemical surfactant |
| Omya BSH | Calcium carbonate |
| NYAD 200 | Wollastonite |
| Talk 1N | talc |
| Aerosil 380 | Fumed silica |
| Ancamine K 54 | tris-2,4,6-dimethylaminomethyl phenol |
| | 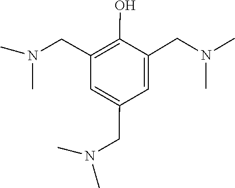 |
| Hycare ATBN | Amine terminated butadiene-acrylonitrile copolymer |
| Amicure CG 1200 | a micronized grade of dicyandiamide |
| Tiona AT 1 | TiO₂ |
| Cabot Ultrabond 5780 | Fumed silica |
| Potter 2024 | Glass microspheres |

D.E.R.™ 331™ Liquid Epoxy Resin is a liquid reaction product of epicholorohydrin and bisphenol A, having an epoxide equivalent weight of 182-192 g/eq (as measured according to ASTM D-1652), an epoxide percentage of 22.4-23.6% (as measured according to ASTM D-1652), an epoxide group content of 5200-5500 mmol/kg (as measured according to ASTM D-1652), and a viscosity at 25° C. of 11000-14000 mPas (as measured according to ASTM D-445).

### Production of Toughener

Tougheners were produced from the ingredients in Table 2.

TABLE 2
Ingredients of tougheners used in the Examples

| | | | Ref. | Toughener | Toughener |
|---|---|---|---|---|---|
| | Example | | Toughener | A | B |
| Comp. A1 | PolyTHF 2000 | % | 53.91 | 82.59 | 66.54 |
| Comp. A4 | PolyVest HT | % | | | 16.64 |
| Comp. B | 1,6 HDI | % | 2.26 | 10.42 | 10.09 |
| Comp. C | 1,6 HDI | % | 4.76 | | |
| Comp. D | TIB KAT 718 | % | | 0.10 | 0.10 |
| | (blend of bismuth | | | | |
| | and zinc | | | | |
| | carboxylates) | | | | |
| Comp. E | DBTL | % | 0.02 | | |
| Comp. F | Cardolite | % | 9.05 | | |
| | NX2026 | | | | |
| Comp. G | CPEE | % | | 6.89 | 6.63 |
| Comp. H | DER330 | % | 30.00 | | |
| | Total | | 100.00 | 100.00 | 100.00 |
| | NCO 1st RS | | 0 | 1.87 | 1.80 |
| | NCO 2nd RS | | 1.37 | — | — |
| | NCO/OH | | 0.996 | — | — |
| | NCO/(OH, | | — | 0.995 | 0.9967 |
| | CPEE) | | | | |
| | d-parameter | | 8.616 | | |
| | Viscosity @ 45° | | 180 | 113 | 215 |
| | C. [Pas] (up/ | | | | |
| | down, 4/20 | | | | |
| | Newt.) | | | | |
| GPC | Mn [g/mol] | | 19100 | 6800 | 9100 |
| | Mw [g/mol] | | 63900 | 13200 | 24300 |
| | PDI | | 3.4 | 1.9 | 2.7 |

### Description of Process to Make Reference Tougheners

Comp. A(X) (poly THF) was added into a lab reactor and heated under stirring and vacuum to 130° C. The mixture was then cooled down with stirring to 70° C. The vacuum was broken and Comp. B (HDI) was added. The mixture was stirred for 2 min under nitrogen, then Comp. E (DBTL) was added. The mixture was allowed to react for 45 min under stirring and nitrogen at 85° C. bath temperature. The isocyanate content was measured, and if it was close to 0%, the mixture was cooled to 70° C. under nitrogen with stirring. When the temperature reached 70° C., premixed Comp. C (HDI) and Comp H (DER330) were added together to the lab reactor. The mixture was allowed to react for 45 min under stirring and nitrogen at 85° C. bath temperature. The isocyanate content was checked (see Table 2, “NCO 2^{nd} RS”). If the NCO content was close to the expected value, Comp. F (Cardolite) was added. The mixture was allowed to react for 45 min under stirring and nitrogen at 85° C. bath temperature. The NCO content was measured. If NCO was close to 0%, the mixture was left to stir for an additional 20 min under vacuum at 85° C. bath temperature.

### Description of Process to Make Inventive Tougheners

Comp. A(X) (poly THF) was added into a lab reactor and heated under stirring and vacuum to 130° C. When the temperature was reached, the mixture was cooled down under stirring to 70° C. The vacuum was broken and Comp. B (HDI) was added. The mixture was mixed for 2 min under nitrogen, then Comp. D (TIB KAT 718) was added. The mixture was allowed to react for 45 min under stirring and nitrogen at 85° C. bath temperature. The NCO content was measured (see Table 2 “NCO 1^{st} RS”). If the NCO content was close to the expected value, the mixture was cooled to 60° C. under nitrogen and stirring. When the material temperature reached 60° C. Comp. G (CPEE) was added. The mixture was allowed to react for 45 min under stirring and nitrogen at 85° C. bath temperature. The NCO content was checked. If the NCO content was close to 0% the mixture was stirred for an additional 20 min under vacuum at 85° C. bath temperature.

### Adhesives

### Component A (Resin Component)

Component A of the adhesives (resin component) were formulated by mixing the ingredients listed in Table 3. The formulations were the same regarding epoxy resins, adhesion promoters and fillers. The only difference was the toughener used. The toughener in comparative resin 1 is diluted in the synthesis with liquid epoxy resin for better processing. The inventive resins 2 and 3 contain a toughener with the inventive capping group CPEE. While the toughener in resin 2 is built from PTHF as the polyol only, in resin 3 the toughener results from a mixture of PTHF and Polybutadiene diols.

TABLE 3
Part A (Resin Component) of adhesives according
to the invention and Comparative Adhesive

| | Comp. | Inv. | Inv. |
|---|---|---|---|
| | Resin 1 | Resin 2 | Resin 3 |
| D.E.R. 331 | 56.00 | 68.5 | 68.5 |
| RAM 1087 | 3.00 | 3.0 | 3.0 |
| Araldit DW 0135 blau | 0.50 | 0.5 | 0.5 |
| Cardolite NC 700 | 0.50 | 0.5 | 0.5 |
| Omya BSH | 2.00 | 2.0 | 2.0 |
| Nyad 200 | 2.00 | 2.0 | 2.0 |
| Cabot Ultrabond 5780 | — | 3.0 | 3.0 |
| Potter 2024 | 1.00 | 1.00 | 1.00 |
| REF. Toughener | 35.00 | — | — |
| (70% toughener + | | | |
| 30% DER330) | | | |
| Toughener A | — | 19.5 | — |
| Toughener B | — | — | 19.5 |
| Yield stress 45° C. [Pa] | — | — | — |
| Plastic Viscosity | — | — | — |
| 45° C. [Pas] | | | |

### Component B (Hardener Component)

Table 4 shows the ingredients of the hardener component used for curing of the three different Component A's in a mixing ratio of A:B of 2:1 applied from a 2:1 side by side cartridge. The Epoxy resin component was filled in the high volume side, the amine hardener in the lower volume side cartridge. The static mixer used was a Sulzer Quadro mixer with 24 mixing elements.

TABLE 4
Part B (Hardener Component) of adhesives according
to the invention and Comparative Adhesive

| | Amine based |
|---|---|
| | Hardener B |
| Mixing ratio | 2:1 |
| Lupasol P | 4.0 |
| Jeffamin T-403 | 28.0 |
| Jeffamin D-400 | 14.0 |
| Jeffamin D-2000 | 5.0 |
| TETA | — |
| 4,7,10-Trioxatridecane-1,13-diamine | 9.0 |
| Ancamine K 54 | 12.0 |
| Hycare ATBN | 11.0 |
| Fluorad FC 4430 | 0.3 |
| Aerosil 380 | 8.0 |
| Talk 1N | 4.0 |
| Amicure CG 1200 | 4.0 |
| Tiona AT 1 | 0.7 |

### Test Methods

### Rheology

Rotatory viscosity/yield stress: Bohlin CS-50 Rheometer, C/P 20, up/down 0.1-20s⁻¹; 45° C.; evaluation according to Casson model

### Thermal Analysis

Dynamic Mechanical Analysis (DMA): Glass transition temperature, T_{g}, was determined by DMA measurement and defined as the maximum of the tan δ.

Test method: Temperature range: 40° C. to +250° C.; frequency: 1 Hz; heating rate: 3° C./min

### Mechanical Testing

Lap shear strength was measured according to DIN EN 1465-2009-07 on DC 04 ZE (steel), thickness 0.7 mm, degreased with heptanes, 10×25 mm bonded area, 0.2 mm adhesive layer thickness. Curing was seven days at room temperature.

Impact peel strength was measured according to BS EN ISO 11343:2003: 20×30 mm bonded area, 0.2 mm adhesive layer thickness used steel: DX 56 Z/DC 04 ZE (steel), thickness 0.7 mm, degreased with heptanes, measured at 23° C., 20×30 mm bonded area, 0.2 mm adhesive layer thickness. Curing was seven days at room temperature.

### Sample Preparation

Metal strips of the given steel grade were cleaned with heptanes in an ultrasonic bath and re-greased by dip coating in a solution of Heptane/Anticorit PL 3802-39S (9/1).

### Tensile Test (DIN ISO EN-527-1:2012-06)

A plate of the cured adhesive was prepared in a thickness of 2 mm and cured at room temperature for 7d. Dog bone shaped specimens were cut out of the plate. The dimensions were according to DIN ISO EN-527-1 and the test was performed accordingly using a zwick tensile tester.

### T-Peel Strength (ISO 11339:2010)

T-Peel strength was measured on DC 04 ZE steel from Thyssen Krupp in 0.7 mm thickness. Glassbeads with a thickness of 0.2 mm were used as spacers between both strips to adjust the adhesive layer to 0.2 mm. The test was performed according DIN 53282. specimens for t-peel testing have DIN 53282 test geometry (30 mm overlay, 20 mm width). Metal clips were used to hold the two strips together during the baking cycle. The adhesive is cured for 7 d at room temperature.

### Impact Peel Test Specimens (ISO 11343:2003)

The adhesive composition was applied to the strips of DC 04 ZE 0.7 mm steel. A 0.2 mm thick PTFE foil and a metal wire (thickness 0.2 mm) were used as spacers between both strips to adjust the adhesive layer to 0.2 mm. The specimens for impact peel testing have ISO 11343 test geometry (30 mm overlay, 20 mm width). Metal clips were used to hold the two strips together during curing. Curing was seven days at room temperature. All coupon/adhesive assemblies were cured in an oven, at 180° C. for 30 minutes. For impact peel testing specimens were subjected to 90 J impact load at a drop weight speed of 2 m/s. Impact peel strength was measured at average impact load at plateau using a Zwick-Roell impact tester.

Table 5 summarises the test results for the inventive and comparative examples. Comparative Example 1 used Comp. Resin 1 as Component A (resin component), whereas Inventive Examples 2 and 3 used Inv. Resin 2 and Inv. Resin 3, respectively, as Component A (resin component).

TABLE 5
Results of mechanical testing of inventive
and comparative examples

| | Comp. | Inv. | Inv. |
|---|---|---|---|
| | Example 1 | Example 2 | Example 3 |
| Epoxy resin formulation | Comp. Resin 1 | Inv. Resin 2 | Inv. Resin 3 |
| Hardener | Amine based | Amine based | Amine based |
| | Hardener B | Hardener B | Hardener B |
| Mixing ratio | 2:1 | 2:1 | 2:1 |
| Mechanical prop. Curing: | | | |
| 7d RT | | | |
| Impact peel strength at | 14 | 19 | 21 |
| 23° C. [N/mm] | | | |
| T-peel strength at 23° C. | 3.0 | 4.1 | 5.4 |
| [N/mm] | | | |
| E-modulus [MPa] | 970 | 1590 | 1820 |
| Tensile strength [MPa] | 21.7 | 26.8 | 31.1 |

The data in Table 5 show that the inventive adhesive, in which the toughener contains a CPEE capping group, performs better in all mechanical characteristics measured than the comparative adhesive, in which the toughener is capped with a phenol.

Comparative Example 1 compares directly to Inventive Example 2, differing only in the toughener terminal capping group. The inventive formulation shows a significantly higher impact peel resistance as well as a significantly higher T-peel resistance over the reference. Also the ultimate tensile strength is 24% higher in Inventive Example 2.

In Inventive Example 3, the incorporation into the toughener backbone of polybutadiene diol in addition to polyTHF results in an even superior performance regarding impact resistance (+50% over Comparative Example 1), T-peel resistance (+80% over Comparative Example 1) as well as tensile strength (+43%) and e-modulus (+88%).

It can be concluded that the use of a blocking group that does not deblock but directly reacts with an amine in the adhesive curing and to react with amines and therewith bond to the matrix resulting improved toughness and hardness at the same time.

1. A two-component epoxy adhesive composition comprising:
Component A comprising:
ai) at least one epoxy resin; and
aii) a reactive toughener made by reacting at least one polyol selected from poly(alkylene oxide)diol, and poly(butadiene)diol with a polyisocyanate in the presence of a polyurethane catalyst, optionally followed by chain extension with a di-phenol, and end-capping with a molecule of Formula I: 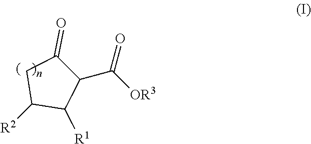
where R¹ and R² are independently selected from hydrogen and C₁ to C₆ alkyl, n is an integer from 1 to 2, and R³ is C₁ to C₆ alkyl; and
Component B comprising:
bi) one or more polyamines;
bii) optionally one or more latent epoxy curing agents; and
biii) one or more epoxy curing catalysts.

2-3. (canceled)

4. The composition of claim 1, wherein the at least one epoxy resin comprises an epoxy having an epoxide percentage of 22.4-23.6% (as measured according to ASTM D-1652), an epoxide group content of 5200-5500 mmol/kg (as measured according to ASTM D-1652).

5. (canceled)

6. The composition of claim 1,
wherein the at least one epoxy resin is used at 50 to 80 wt %, based on the total weight of Component A of the adhesive composition.

7. The composition of claim 1,
wherein R¹ and R² are independently selected from H and C₁ to C₄ alkyl.

8. The composition of claim 7,
wherein R¹ and R² are independently selected from H and C₁ to C₂ alkyl.

9. The composition of claim 8,
wherein R¹ and R² are H.

10. The composition of claim 1,
wherein R³ is C₁ to C₄ alkyl.

11. The composition of claim 10,
wherein R³ is C₁ to C₂ alkyl.

12. The composition of claim 11,
wherein R³ is ethyl.

13. The composition of claim 1,
wherein n is 1.

14. The composition of claim 1,
wherein the end-capping molecule is ethyl-2-oxocyclopentanecarboxylate.

15. The composition of claim 1,
wherein the poly(alkylene oxide)diol used in the toughener is selected from poly(C₂-C₆ alkylene oxide) diols.

16. The composition of claim 15,
wherein the poly(alkylene oxide)diol used in the toughener is selected from poly(tetramethylene oxide)diol (“PTMEG”), poly(trimethylene oxide)diol (“PO3G”), and mixtures thereof.

17-19. (canceled)

20. The composition of claim 1,
wherein poly(butadiene)diol (“PBD”) is used in the toughener.

21-24. (canceled)

25. The composition of claim 1,
wherein the polyisocyanate is selected from 1,6-hexamethylenediisocyanate (“HMDI”), isophorone diisocyanate (IPDI), and mixtures thereof.

26-28. (canceled)

29. The composition of claim 1,
wherein the polyurethane catalyst is selected from dibutyltin dilaurate (“DBTL”) and metal carboxylates.

30. (canceled)

31. The composition of claim 1,
wherein the polyurethane catalyst is a mixture of bismuth and zinc carboxylates.

32-36. (canceled)

37. The composition of claim 1,
wherein at least one polyamine in Component B has an amine functionality of 2 or greater.

38. The composition of claim 1,
wherein at least one polyamine in Component B comprises at least one molecule having an amine functionality of 10 or greater, in combination with at least one diamine.

39-44. (canceled)

45. The composition of claim 1,
wherein the latent epoxy curing agent is selected from boron trichloride/amine and boron trifluoride/amine complexes, melamine, diallylmelamine, guanamines, methyl guanidine, dimethyl guanidine, trimethyl guanidine, tetramethyl guanidine, methylisobiguanidine, dimethylisobiguanidine, tetramethylisobiguandidine, heptamethylisobiguanidine, hexamethylisobiguanidine, acetoguanamine, benzoguanamine, aminotriazoles, hydrazides, stearic dihydrazide, isophthalic dihydrazide, semicarbazide, cyanoacetamide, and aromatic polyamines.

46-54. (canceled)
